(19) United States
(12) Patent Application Publication
(10) Pub. No.: US 2010/0191635 A1
(43) Pub. Date: Jul. 29, 2010

(54) CONSTANT GROWTH MORTGAGES AND METHODS OF THEIR CALCULATION

(76) Inventor: Brian Lee Whitworth, Dallas, TX (US)

Correspondence Address: Myers Andras Sherman LLP, 19900 MacArthur Blvd., Suite 1150, Irvine, CA, 92612, US

(21) Appl. No.: 12/542,142

(22) Filed: Aug. 17, 2009

Related U.S. Application Data
(60) Provisional application No. 61/206,109, filed on Jan. 28, 2009.

(51) Int. Cl. G06Q 40/00; G06Q 90/00

(52) U.S. Cl. 705/35; 705/500

(57) ABSTRACT

Systems, apparatuses and methods are described for Constant Growth Mortgages. Such Constant Growth Mortgages can be used for new purchases, refinances, or loan workouts. If desired, the system can be used to calculated Constant Growth Mortgages which avoid negative amortization throughout the payment stream. Other constraints such as maximum or minimum loan to value ratio, payment as a percentage of current income, or absolute dollar value of payment can also be incorporated. An example system makes use of Constant Growth Mortgages for loan modifications which reduce near term payments while avoiding negative amortization.

### CROSS REFERENCE TO RELATED APPLICATION

This application relates to and claims priority from the following U.S. Provisional Application Ser. No. 61/206,109, filed Jan. 28, 2009.

### TECHNICAL FIELD

The present invention relates to a system and method for creating mortgages whose payments grow at a constant and definite rate over the term of a particular mortgage, reducing initial payments and allowing lenders to avoid negative amortization.

### BACKGROUND ART

Mortgages currently come in a wide variety of forms, including: traditional fixed interest rate, variable interest based upon an underlying index (e.g., LIBOR or US treasury interest rates), teasers, balloon payments, fixed for an initial term then converting to floating, and many others.

Adjustable rate mortgages have the disadvantage of payment uncertainty for the borrower. Even with limits on maximum payments, interest rates, or speed of adjustments, mortgage payments will still vary in ways which are not predictable in advance. This produces planning challenges and potential liquidity or solvency difficulties for borrowers.

Traditional fixed rate mortgages (TFRMs) have payments which are certain, as long as payments are made on time and the home is not sold. Because of wage and price inflation, this typically means that the first few mortgage payments are much higher in real dollar terms than the last few payments. For example, a traditional mortgage payment of $100 starting in 1978 would still have been $100 (nominal) as the 30 year mortgage approached payoff in 2008. However, because of inflation $100 in 2008 was the equivalent of $30.69 in 1978 (source: US Bureau of Labor Statistics). Thus, the real value of the last mortgage payment in 2008 was less than one third of the real value of the initial payment in 1978. Because of wage inflation and typical life-cycle income patterns, the last mortgage payment was probably also a much smaller percentage of the owners' gross income than the first payment.

A Graduated Payment Mortgage has been offered by the US Federal Housing Administration for new loans, and has eligibility limitations. It is described as follows:
“Of the five FHA Graduated Payment Mortgage plans, three of them allow mortgage payments to increase at a rate of 2.5 percent, 5 percent, or 7.5 percent in the first 5 years of the loan. Through the other two plans, payments increase at a rate of 2 to 3 percent annually over 10 years. Beginning in the sixth year of the 5 year plans and in the eleventh year of the 10 year plans, payments stay the same for the remaining years of the mortgage. FHA mortgages that start with a greater rate of increase over a longer period will have lower payments in the early years.”

Graduated Payment Mortgages usually have negative amortization: loan balances increase in the early years of the loan, increasing the risk of loss and making them less desirable in periods of declining home prices. The rate of increase of the payment stream during the 5 or 10 year period is the same regardless of the interest rate on the mortgage.

Current efforts at mortgage modifications frequently require substantial time, information, and judgment. Substantial numbers of modification requests are rejected. Current forms of mortgage modification have a problem with “forgone income” which the current invention cures. An analysis of problems with existing mortgage modifications states:
“Our empirical and theoretical results imply that the number of borrowers who would qualify for an assistance policy can be far greater than the number of borrowers who truly need help. In other words, the costs of forgone income from borrowers who would have made payments often exceeds the benefits of fewer foreclosures.”—“Negative Equity and Foreclosure: Theory and Evidence”—Christopher L. Foote, Kristopher Gerardi, and Paul S. Willen, Federal Reserve Board, June 2008.

### SUMMARY OF THE INVENTION

Embodiments described herein involve systems, apparatuses and methods related to Constant Growth Mortgages (CGMs), which seek to provide: certainty of payments (to aid in planning and reduce budget volatility), and affordability (payments are lower than traditional fixed rate mortgages during the early years of the loan). As a result of the predictability and affordability, Constant Growth Mortgages would likely have lower default rates than purchasing the same house with the same downpayment via most currently available mortgage types. CGMs also allow more people to qualify under affordability criteria that are based on debt service ratios.

A CGM with no negative amortization is a particularly good option for modifications of existing loans. It allows a lender to lower mortgage payments for many years without reducing either interest rate or principal. This can allow much faster loan modifications with less administrative work. Many lenders may find it efficient to offer such loan modifications regardless of whether a borrower is currently delinquent or distressed.

In those cases where interest rate or principal are reduced as part of a loan modification, a CGM can result in additional reductions in near-term mortgage payments. When a CGM is used to replace an adjustable rate mortgage, it also replaces uncertain future payments with known payments.

In accordance with an exemplary embodiment of the present invention, Constant Growth Mortgages (CGM), a method adapted to: create mortgage payments of definite term, definite interest rate, definite payment amounts, and definite rate of increase of payments over time.

It is further shown that for a particular combination of term, payment frequency, and interest rate, a particular maximum rate of increase of payments over time can be calculated such that there is never negative amortization: the outstanding principal throughout the life of the mortgage will never exceed the principal at inception.

In another aspect of the current invention methods for using CGM in workouts and refinancing are shown.

### BRIEF DESCRIPTION OF THE DRAWINGS

FIG. 1 is a high level, functional flowchart of an exemplary system according to the present invention.

FIG. 2 is a flowchart showing an exemplary method for calculating a Constant Growth Mortgage payment stream.

FIG. 3 is a flowchart showing calculation of a CGM where the interest rate and term are fixed, and the growth rate is varied in order obtain a desired initial payment level.

FIG. 4 s a flowchart showing calculation of a CGM where the growth rate and term are fixed, and the interest rate is varied in order obtain a desired initial payment level.

FIG. 5 is a flowchart showing how to calculate a CGM which has the highest growth rate which does not cause negative amortization of the mortgage.

FIG. 6 is a chart showing a curve of maximum growth rates with no negative amortization as a function of interest rates for 30 year mortgages.

FIG. 7 is a chart showing the first payment on a no negative amortization CGM as a percent of a traditional fixed rate mortgage, as a function of interest rates.

FIG. 8 is a chart showing payments on different types of mortgages over a period of 30 years.

FIG. 9 is a chart showing amortization of different types of mortgages over a period of 30 years.

FIG. 10 is a flowchart showing how to calculate a CGM which has payments and a growth rate which does not violate multiple constraints.

FIG. 11 is a spreadsheet showing exemplary calculations for the process in FIG. 10.

FIG. 12 is a flowchart of refinancing from a previous mortgage to a CGM.

### DISCLOSURE OF THE INVENTION

An exemplary embodiment of the present invention is adapted to calculation and use of Constant Growth Mortgages (CGMs).

Methods are disclosed for using CGMs for initial purchase, for financing homes which are bank-owned, for refinancing with a different lender, and for a lender or servicer to modify terms of an existing loan.

### Overview

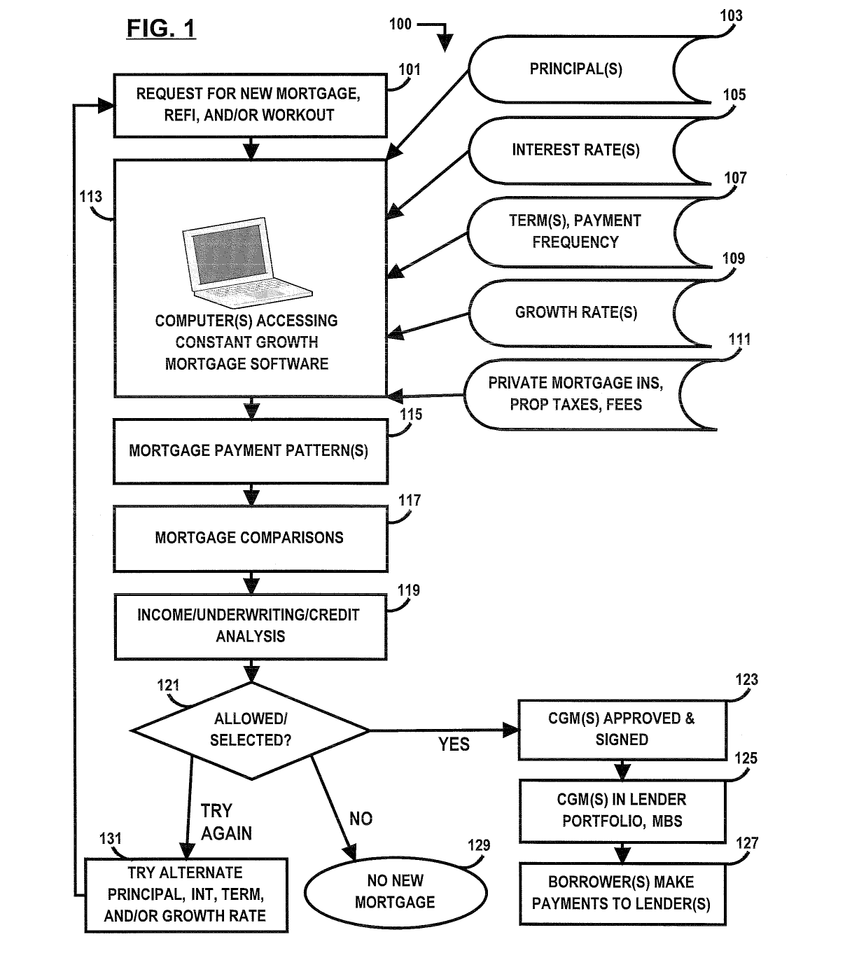

Referring to FIG. 1, an exemplary system 100 according to the present invention includes a computer accessing Constant Growth Mortgage software 113. Said software might be on the internet, a mainframe computer, a networked computer, a personal computer, other computer types or applications, on paper, or various combinations thereof. The preferred embodiment assumes the use of computer software. However, it is possible to do all calculations on paper, with a handheld calculator, an abacus, or other means.

A request or inquiry for a new mortgage, a refinance, or a workout initiates the process 101. The types of mortgage(s) could include: new construction, an existing home being purchased, replacement of an existing mortgage by one or more lenders with a new mortgage with one or more different lenders, a modification or replacement of an existing performing (nondelinquent) mortgage without change of lender(s), or a modification or replacement of an existing delinquent or defaulted mortgage without change of lender(s). A request might be initiated by one or more borrowers, one or more lenders, one or more loan servicers, courts, regulators, or others.

Mortgage principal 103 might include points, accrued interest, penalties, and other fees. Multiple principals might be considered. For example, different down payment amounts often lead to different interest rates or different requirements regarding private mortgage insurance. One or more interest rate(s) 105 might include different interest rates for many alternative mortgages, including: different principal or downpayment amounts, different points at origination, different loan terms, and different payment frequencies. Mortgage terms and payment frequencies 107 might be a single value for (such as monthly payments for 30 years), or might include a variety of options, such as weekly or monthly payment, or 15, 30, or 40 year loan terms. Particularly in the case of refinancing and workouts, nonstandard terms may often be used. For example, a particular existing mortgage might have 28 years and 4 months remaining. A refinance or workout using a CGM might use that same remaining term of 28 years and 4 months. A desired or preliminary growth rate may be specified 109.

Many mortgages will include ongoing fees such as private mortgage insurance, property taxes 111.

Information in 103, 105, 107, 109, and/or 111 might originate from multiple sources, and might be maintained in one database, multiple databases, be available online, or could be maintained on paper.

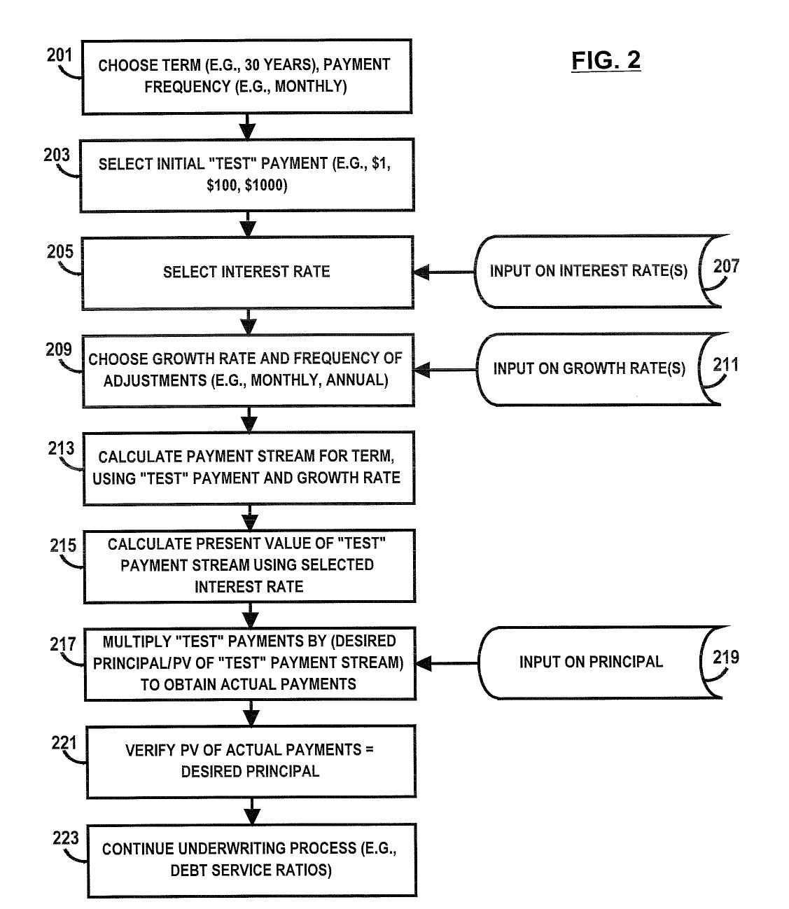

One or more computers accessing Constant Growth Mortgage software 113 produces one or more mortgage payment patterns 115. The Constant Growth Mortgage software is described more fully in FIGS. 2-5. A mortgage payment pattern consists of a listing of each and every payment.

Various mortgages are compared at 117. For refinances and workouts, payments on one or more existing loans may be included. One or more potential new CGM payment streams are compared. Comparisons may also include mortgage amortization patterns, affordability, risk analysis, and others.

Income, underwriting, and/or credit analysis 119 allows one or more lenders (or potential lenders) to evaluate the loans based on factors such as affordability, debt to income ratio(s), loan to value ratio(s), or other criteria.

If a particular CGM is allowed by the lender(s) and selected by the borrower(s) 121, the CGM is approved and signed by the relevant parties (e.g., borrower(s) and lender(s), servicer(s), and/or mortgage broker(s)) 123. In that case, the new mortgage, refinance, or workout is in a lender(s) portfolio, mortgage backed security portfolio, or other portfolio 125. One or more borrowers then make payments on one or more CGMs, and those payments are received by one or more lender(s) 127.

If either the lender(s) or the borrower(s) do not agree to a new mortgage, and do not want to investigate other alternatives, the process ends with no new mortgage 129. Alternatively, the process can be tried again with different principal(s), interest rate(s), term(s), growth rate(s), or other factors 131. In that case the process starts over at 101.

### Calculating a Constant Growth Mortgage Payment Stream

FIG. 2 is a flowchart showing an exemplary method for calculating a Constant Growth Mortgage payment stream. FIG. 2 shows the calculation of a single CGM. There are many circumstances where calculations of multiple CGMs will be desired. The process can be repeated an unlimited number of times with different inputs, such as interest rate, growth rate, frequency of adjustment, term, and/or principal. The process might be performed on a mortgage-by-mortgage basis, or results for a variety of different interest rates, terms, etc., might be calculated in order to make charts or tables.

Term and frequency of payment are chosen 201. For new mortgages, these will commonly be 15, 30, or 40 year mortgages with monthly payments. For refinance and/or workouts, other terms will be common.

An initial “test” payment is chosen, such as $1, $100, or $1000 at 203. There are very few constraints on the initial “test” payment. A user could throw darts or consult a random number table for a “test” payment and will still arrive at the same final CGM payment stream for the same underlying assumptions. Any “test” payment greater than zero will work.

An interest rate is selected 205, using input on interest rates 207. An interest rate could be selected based on a wide variety of sources and circumstances.

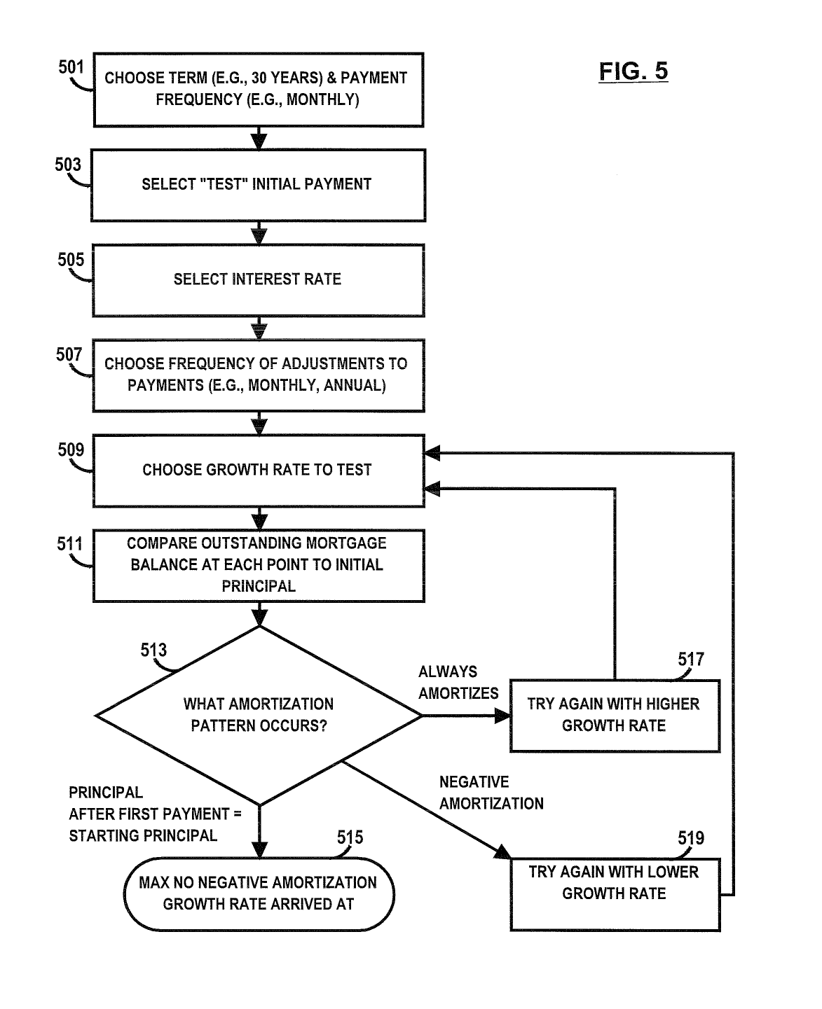

A growth rate and frequency of adjustment is selected 209 based on input on growth rates 211. As is described later in FIG. 5, there is a unique maximum growth rate for any particular interest rate and term which avoids negative amortization. There might be other restrictions imposed on the growth rate, such as it should never exceed a particular rate (e.g., long term historic inflation, or expected future inflation) regardless of the interest rate.

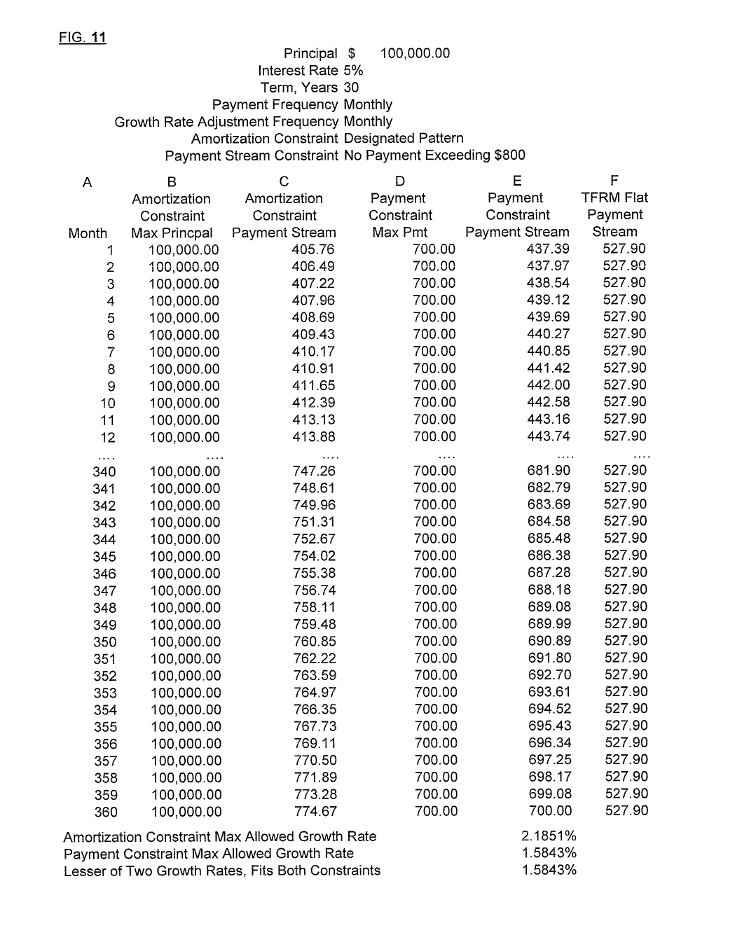

A payment stream is calculated 213, starting with the “test” payment for the first payment. Later payments increase by the chosen growth rate and frequency until the end of the term. For example, payments might increase monthly, but at a 2% annual rate of increase. Or, payments might increase by 2% with only one adjustment annually. For a given term and frequency, there will be a definite number of payments. For example, 30 years of monthly payments result in 360 payments. Examples of such payment streams for 30 year mortgages are shown in FIG. 11.

The present value of the “test” payment stream is calculated 215, using the interest rate selected in 205. In order to resize the “test” payment stream to a particular principal 217 each payment in said stream is multiplied by:

desired principal/present value of “test” payment stream

For example, if the present value of the “test” stream is $412,641.22, and the desired principal from input on principal 219 is $200,000, each payment in the “test” stream is multiplied by ($200,000/$412,641.22) to obtain the actual payment stream.

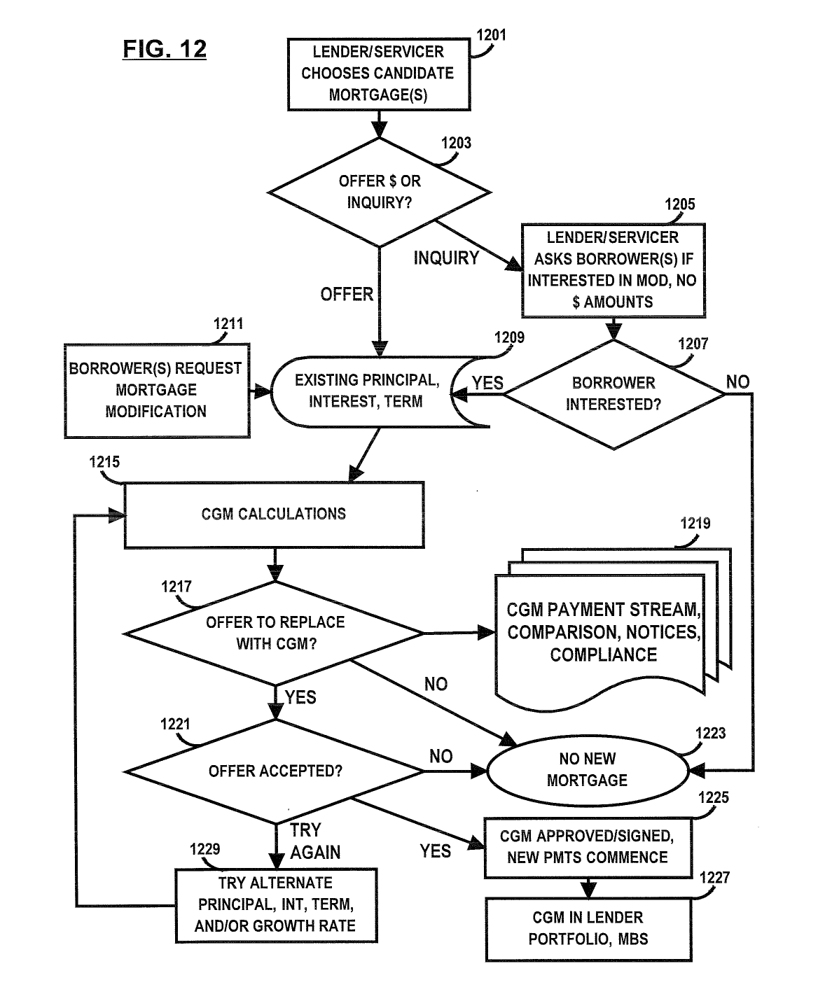

The present value of actual payment stream at the selected interest rate is verified 221, and then the process continues to any applicable underwriting process(es) 223. The process in FIG. 2 could be used for new mortgages, refinancing, or workouts. A more detailed and customized method for workouts is in FIG. 12.

### Varying CGM Growth Rate to Achieve Target Initial Payment

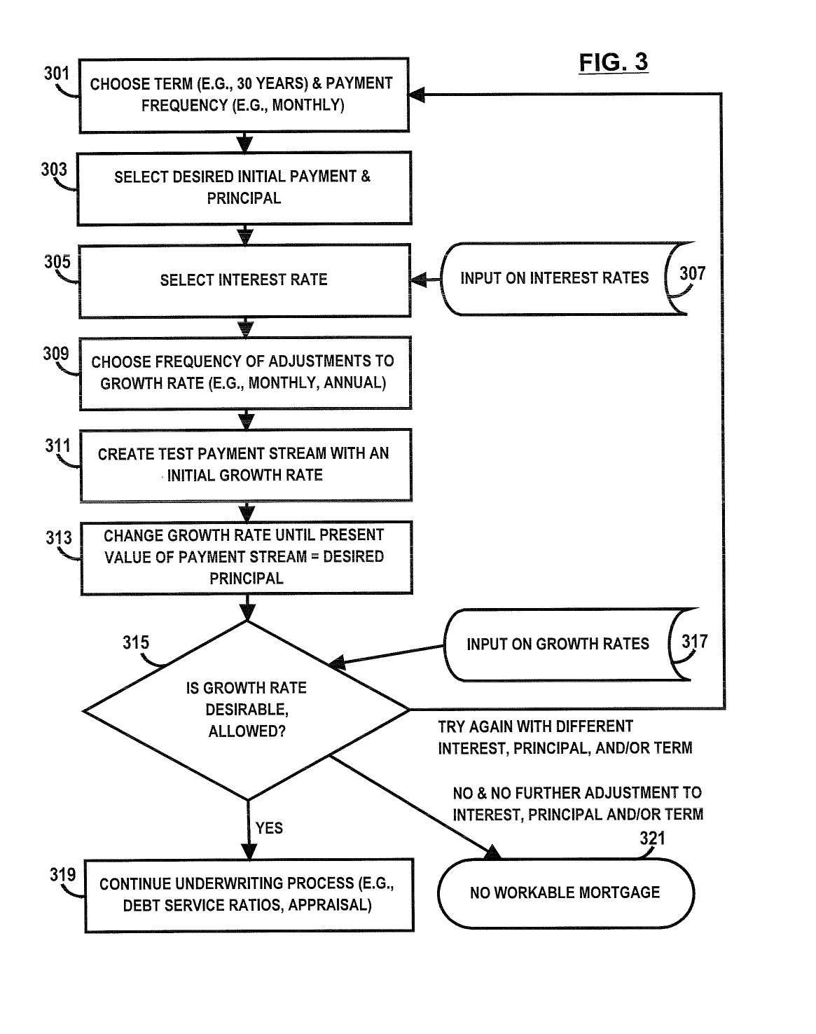

FIG. 3 is a flowchart showing calculation of a CGM where the interest rate and term are fixed, and the growth rate is varied in order obtain a desired initial payment level.

In FIG. 2, principal, interest rate, term, and growth rate were chosen and a payment pattern was the output. In contrast, FIG. 3 involves setting a desired initial payment level, principal, interest and term, and solving for the matching growth rate which achieves the desired initial payment.

A term and payment frequency are chosen 301, and a desired initial payment and principal are selected 303. An interest rate is selected 305, in consideration of information on interest rates 307 Similar to 205 and 207 of FIG. 2, an interest rate could be selected based on a wide variety of sources and circumstances. A frequency of growth rate adjustments is chosen 309. Examples of frequency of adjustments include monthly and annual.

At 311, an initial “test” growth rate is chosen to generate a “test” payment stream. At 313, the growth rate is changed until:

present value of the payment stream=desired principal

Different techniques can be used to arrive at the growth rate. A user could start at zero growth and keep raising the growth rate until the present value of the payment stream exceeds the desired principal and then drop the growth rate by small increments until the present value converged to the desired principal. A similar approach involves starting with a high “test” growth rate and dropping it in increments to converge on the desired principal. While not particularly efficient, trial and error may work. Fortunately, widely available tools such as Goal Seek in Excel are adapted to solve for the growth rate. In Excel 2000, the cell containing the present value of the payment stream is set to a goal value of the principal by changing the cell containing the growth rate.

There is always a growth rate which will provide a solution when initial payment, principal, and interest are nonzero, and there is more than one payment. That growth rate could be zero, in which case the CGM is equivalent to a traditional fixed rate mortgage. The growth rate which provides a solution could potentially be negative.

If the initial payment is quite low in relation to the other variables, lender(s) and/or borrower(s) may find the growth rate undesirable. An extreme example can illustrate this situation. Assume a prospective buyer wants a one million dollar CGM with an initial payment of $1 per month. This can be achieved, but the mortgage payments would rise by almost 50% per year, every year, for 30 years. In the early years of the mortgage, there would be very large negative amortization. Including negative amortization, the loan value would peak at over $3.5 million. Toward the end of the mortgage, payments would be immense, rising to over $160,000 per month. An astute lender would realize the large risks of making such a loan.

At 315, a decision is made regarding whether the growth rate is desirable or allowed using input on growth rates 317. The decision might include underwriting guidelines, restrictions on negative amortization, legal limits on maximum growth rates, or statistical modeling of historic or expected default rates or inflation.

If the growth rate is viewed as desirable and allowed, the underwriting process continues at 319. If the growth rate is not desirable, or not allowed, and the lender does not want to adjust (or cannot adjust) principal, interest, or term, there is no workable CGM and the process terminates 321.

The lender(s), servicer(s), or mortgage broker(s) might also try alternative CGMs with different interest, principal, and/or term. One potential example is a different downpayment might make a borrower eligible for more favorable interest payments. Another example is that a lower priced home would lead to an acceptable result. To investigate alternative arrangements, the process is repeated at 301 with changes to principal, interest, and/or term.

### Varying Interest Rate to Achieve Target Initial Payment

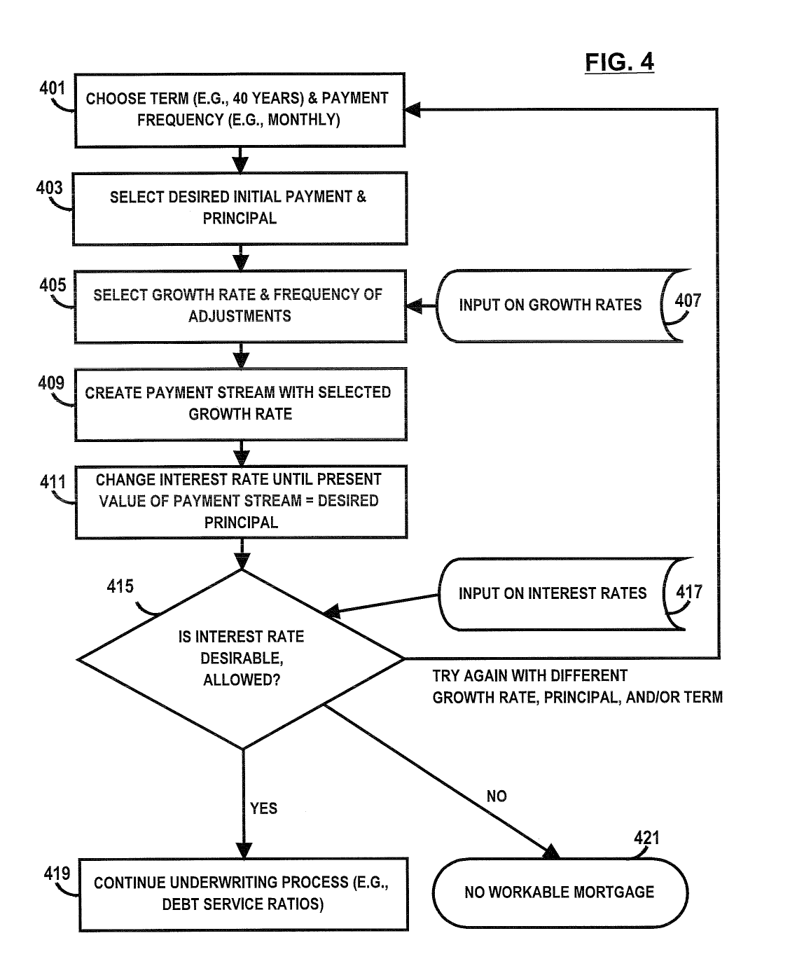

FIG. 4 is a flowchart showing calculation of a CGM where the growth rate and term are fixed, and the interest rate is varied in order obtain a desired initial payment level.

This is a similar process to FIG. 3, where the growth rate was varied. However, there are some differences. For a particular desired initial payment, principal, term and growth rate, there is not necessarily a positive interest rate where the present value of the payment stream equals the desired principal. In practice, it is very rare for any lender to be willing to receive negative interest rates, regardless of the borrower(s) or circumstances.

A term and payment frequency are chosen 401, and a desired initial payment and principal are selected 403. A growth rate and frequency of growth rate adjustments are selected 405, in consideration of information on growth rates 407. A payment stream is created with the select growth rate and frequency 409. The first payment in the stream is the desired initial payment from 403.

At 411, an initial “test” interest rate is chosen. This interest rate is used to present value the stream of payments in 409. At 411, the interest rate is changed until:

present value of the payment stream=desired principal

Similar to 313 of FIG. 3, different techniques can be used to arrive at the interest rate. Goal Seek in Excel is adapted to solve for the interest rate in 411.

The interest rate arrived at in 411 might or might not be desirable. Input on interest rates 417 is used in that decision. The decision might include underwriting guidelines, restrictions on allowed interest rates (e.g., greater than zero and less than usury), cost(s) of capital, or statistical modeling of historic or expected inflation 415.

If the interest rate is viewed as desirable and allowed, the underwriting process continues at 419. If the interest rate is not desirable, or not allowed, and the lender does not want to adjust (or cannot adjust) principal, growth rate, or term, there is no workable CGM and the process terminates 421.

The lender(s), servicer(s), or mortgage broker(s) might also try alternative CGMs with different interest, growth rate, principal, and/or term. One potential example is a different downpayment might make a borrower eligible for more favorable interest payments. Another example is that a lower priced home would lead to an acceptable result. To investigate alternative arrangements, the process is repeated at 401 with changes to principal, interest growth rate and/or term.

### Calculating the Highest Growth Rate Which Does Not Cause Negative Amortization

FIG. 5 is a flowchart showing how to calculate a CGM which has the highest growth rate which does not cause negative amortization of the mortgage for a particular interest rate and term. Note that this result is independent of principal and does not require a desired initial payment, any “test” payment will do.

The calculation of the maximum growth rate which does not cause negative amortization is novel and can be useful for many reasons, including:
1. Many lenders are averse to negatively amortizing loans. Such loans were a major factor in the largest US bank/savings & loan insolvency of all time: Washington Mutual.
2. Regulatory changes may make negatively amortizing mortgages more difficult to originate in the future.
3. Many loan servicers are able to do modifications of existing mortgages which do not add to the loan balance more easily than other modifications.
4. Negative amortization increases the likelihood of foreclosure, and results in larger loan losses when foreclosure occurs. Many existing teasers and adjustable rate mortgages have negative amortization. Using a CGM and a lower interest rate, CGMs can often be used to replace existing loans while allowing lower payments and avoiding negative amortization.
5. For existing mortgages where a loan modification under consideration includes reducing interest, the combination of reduced interest and a CGM without negative amortization can provide very large reductions in payment. For example, a 30 year TFRM at 8% interest modified to a CGM with 5% interest could reduce near term payments by over 43%. The combined effect on affordability can be immense and can reduce default rates.
6. Many potential borrowers are concerned about owing more on a mortgage after several years than when they purchased or refinanced their home.
7. For mortgages with interest rates falling within the range of historical US experience (˜4.9% to 18.5%), the highest growth rate which does not cause negative amortization is less than average historical rates of inflation (˜2.5% to 4.0% depending on the method of measurement and time horizon). If future inflation is similar to historical inflation rates, payments on a CGM will drop very slowly in real terms, or as a percentage of wages and income. Note that if a mortgage was indexed to actual inflation rather than using a CGM, the inflation-indexed mortgage would have problems with unpredictable payments in both the short and long term.
   Referring to FIG. 5, a term and payment frequency are chosen 501. For example, monthly payments for 30 years. An initial “test” payment is selected 503. An interest rate is also selected 505. A frequency of adjustments to payments is chosen (e.g., growth rate is applied monthly or annually) 507.

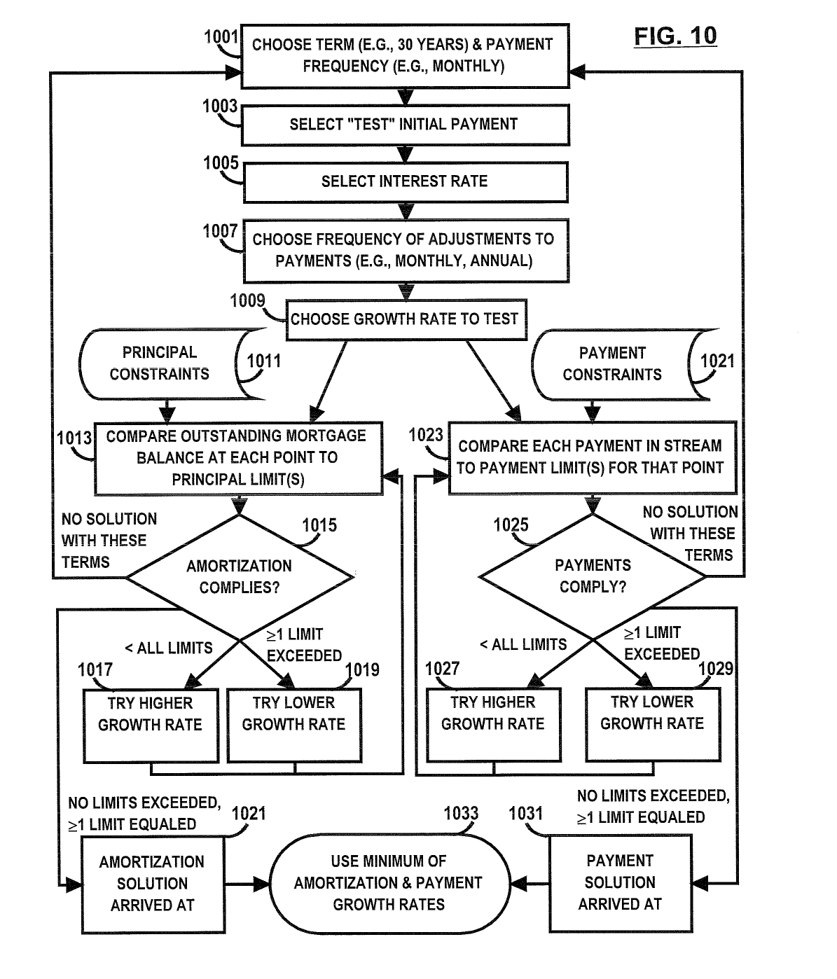

At 509 a growth rate is chosen to test. There are multiple methods which can arrive at the largest growth rate which does not negatively amortize. One method involves testing each point along the amortization curve to see if the loan balance is less than or equal to the starting balance 511. This method of testing each point on the CGM amortization curve can also be adapted to other types of constraints, as described later in FIG. 10.

Depending on the type of amortization pattern which occurs, the “test” growth rate may be too high, too low, or exactly right 513. If the CGM amortizes with every payment, a higher growth rate is tried for another iteration 517, and the process returns to 509. If the CGM has negative amortization at any point, a lower growth rate is tried for another iteration 519, and the process returns to 509.

In practice, if the outstanding principal after the first payment=the initial principal, all later payments on a CGM will reduce outstanding principal, and the growth rate is the highest rate CGM which does not produce negative amortization at any point 515. The highest growth rate which does not cause negative amortization has been found.

If a user would like to repeat similar calculations with different interest rates, terms, or other different assumptions, the process in FIG. 5 can be repeated as many times as needed.

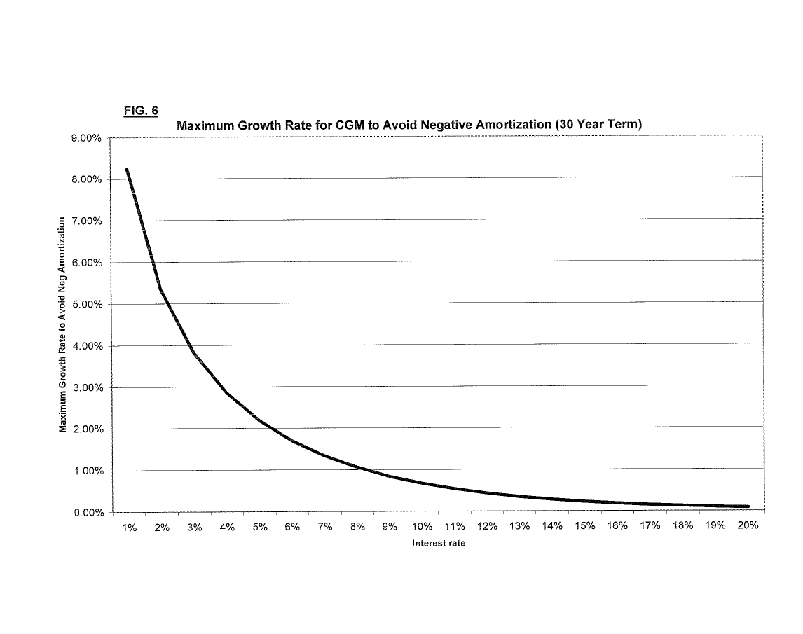

Repeating the process for a variety of different interest rates can produce a table or chart of such growth rates in relation to interest rates, as shown in FIG. 6. As can be seen in the chart in FIG. 6, the maximum CGM growth rate to avoid negative amortization is considerably greater at lower interest rates.

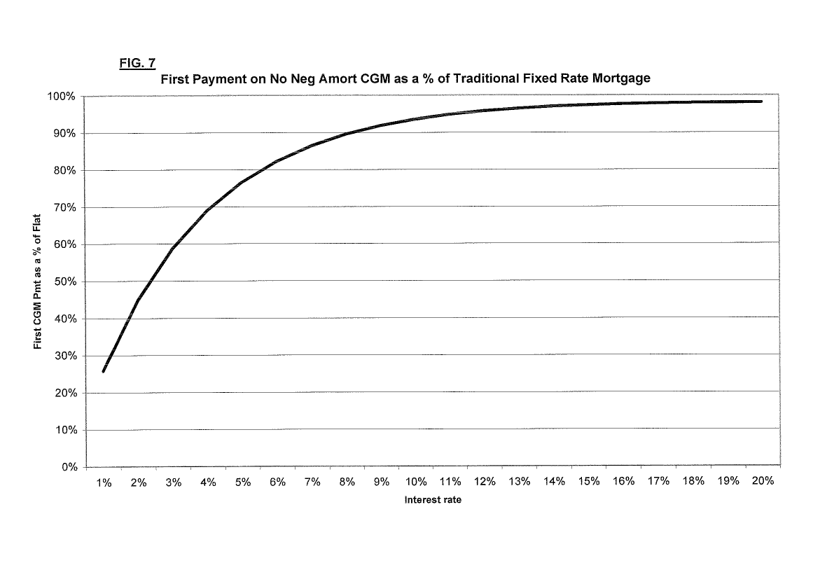

The larger CGM growth rates at lower interest rates result in first mortgage payments which are far less than TFRMs at the same interest rates, as shown in the chart for 30 year mortgages in FIG. 7.

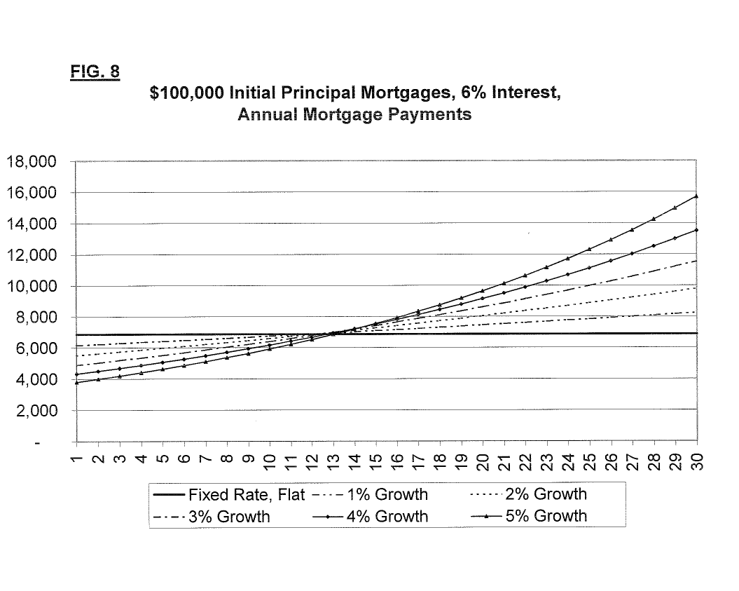

FIG. 8 is a chart displaying annual mortgage payments for a traditional fixed rate mortgage and CGMs with growth rates ranging from 1%-5%. All mortgages have an initial principal of $100,000 and an interest rate of 6%. The lowest initial payments are for the CGM with the highest growth rate (5%).

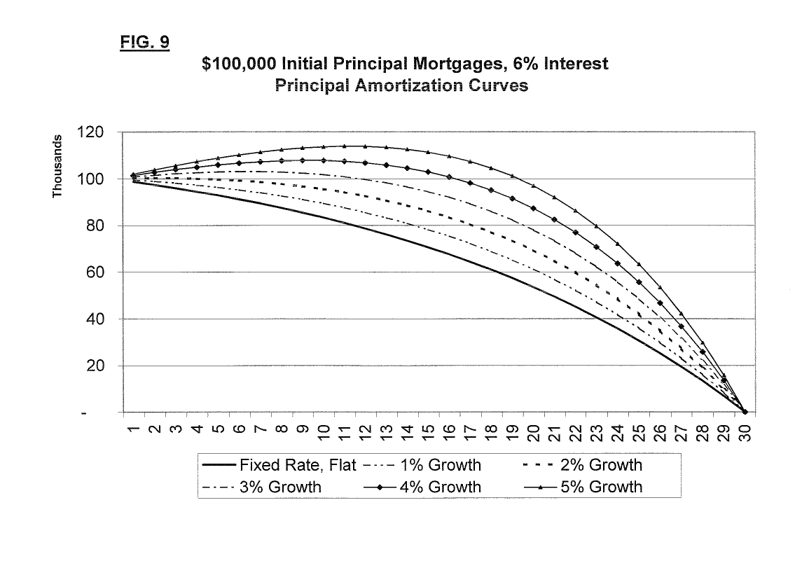

FIG. 9 is a chart displaying principal amortization curves for the same traditional fixed rate mortgage and CGMs with growth rates ranging from 1%-5% as FIG. 8. The highest growth rate CGMs have negative amortization in the early years. The CGM with a 2% growth rate has slight negative amortization, and the CGM with a 1% growth rate has no negative amortization.

### Calculating Maximum Growth Rates With More General Constraints

FIG. 10 describes a calculation somewhat similar to the no negative arbitrage calculation in FIG. 5. However, the maximum allowed outstanding mortgage value can be generalized to a broad variety of possible values. For example, the outstanding principal at any point could be set not to exceed: forecast(s) of future home values derived from information on a futures and/or options exchange (e.g., Case Shiller futures on the Chicago Mercantile Exchange); forecast(s) of future home values derived from one or more other source(s); a maximum outstanding loan value to purchase price; current home prices adjusted for expected future overall inflation; or an arbitrary amortization schedule. Other types of constraints can also be added. In FIG. 10 constraints on payment levels are added.

Steps 1001, 1003, 1005, 1007, and 1009 are essentially the same as 501 to 509 of FIG. 5. A term and payment frequency are chosen 1001. For example, monthly payments for 30 years. An initial “test” payment is selected 1003. An interest rate is also selected 1005. A frequency of adjustments to payments is chosen (e.g., growth rate is applied monthly or annually) 1007. At 1009 a growth rate is chosen to test.

Using input on principal constraints 1011, each point on the test CGM amortization pattern is compared to the limits placed on the amortization schedule 1013. While most examples of limits on amortization are expected to be of the “not to exceed” variety, the method will accommodate constraints of the “not to drop below” variety. If all constraints are of the not to exceed variety, at each point on the amortization curve, the remaining principal of the CGM is subtracted from the maximum allowed remaining principal for that point in time. If a CGM fits the “not to exceed” constraint at a particular point in time:

Maximum Allowed Remaining Principal at Time t−CGM Outstanding Principal at Time t≧0

If there are multiple “not to exceed” constraints, the most restrictive is used at each point in time.

For a “not to drop below” constraint at a particular point in time:

Minimum Allowed Remaining Principal at Time t−CGM Outstanding Principal at Time t≦0

Similarly, if there are multiple “not to drop below” constraints, the most restrictive is used at each point in time. For this example, we assume only “not to exceed” limits. Depending on how and whether the amortization pattern complies with the constraints, the process can branch in several directions 1015. If no limits are equaled or exceeded, the process returns to 1013 to try again with a higher growth rate 1017. If at least one limit is exceeded, a lower growth rate is tried 1019, and the process returns to 1013.

Note that especially if both “not to exceed” and “not to drop below” constraints are used at the same time, there might not be a solution satisfying all constraints. In the case of no solution, the process optionally returns to 1001, and different principal, interest, term, growth rate, or constraints may be used.

If at least one limit is equaled, and none are exceeded, the maximum compliant growth rate for amortization constraints has been found, and the process continues at 1021.

Using input on payment constraints 1021, each point on the test payment stream is compared to the limits placed on the payment stream 1023. This process is similar to the process for adjusting the growth rate to comply with amortization constraints. Depending on how and whether the payment stream complies with the constraint(s), the process can branch in several directions 1025. If no limits are equaled or exceeded, the process returns to 1023 to try again with a higher growth rate 1027. If at least one limit is exceeded, a lower growth rate is tried 1029, and the process returns to 1023.

If at least one limit is equaled, and none are exceeded, the maximum compliant growth rate for amortization constraints has been found, and the process continues at 1031. The minimum of the amortization growth rate solution 1021, and the payment solution growth rate 1031, is used at 1033. The growth rate 1033 satisfies both amortization and payment constraints.

Since both payments and amortization are a function of the growth rate, changing the growth rate can often find a CGM which satisfies constraints on both payments and amortization. For example, Constraint 1=no negative amortization. Constraint 2=payments cannot rise by more than 2% annually. Which constraint is binding depends on the interest rate.

Note that if multiple constraints are used, one or more constraints may not be binding. Since different constraints might come from different sources (e.g., lender policy, Federal regulation, state regulation, borrower request), having one or more constraints be nonbonding would not be surprising.

Not all sets of constraints will have a solution. Revisit the earlier problem of a buyer wanting to purchase a million dollar home with a starting payment of $1 per month. Constraint 1=initial payment $1. Then set Constraint 2=no negative amortization. For most interest rates one would likely encounter, there is no solution satisfying both constraints. However, if the interest rate is zero (i.e., a noninterest-bearing loan), there is a solution, $1 initial payment, 29.16% annual growth rate of payments, and a 30 year term. With a zero interest rate, any payment at all constitutes amortization.

As more constraints are added, there is an increasing chance that no payment pattern can satisfy all of the constraints. This is more likely if constraints apply to more types of variables (e.g., amortization, monthly payment, interest rate and growth rate, term) and if some constraints are “not to exceed” while others are “not to drop below” constraints.

### Example Calculation Using Two Types of Constraints

FIG. 11 is a spreadsheet showing exemplary calculations for the process in FIG. 10. Subject to the constraint in Column B (no negative amortization), the payment stream in Column C has the highest growth rate and lowest initial payment for the designated interest rate, term, payment frequency, and frequency of adjustments.

Subject to the constraint in Column D (payments never exceed $700 per month), the payment stream in Column E has the highest growth rate and lowest initial payment for the designated interest rate, term, payment frequency, and frequency of adjustments.

In this example, the maximum payment constraint resulted in a lower allowed growth rate than the amortization constraint (1.5443% vs 2.1851%). The lower growth rate of 1.5443% will accommodate both sets of constraints.

The flat payment stream which would result from a traditional fixed rate mortgage in Column F is shown for comparison only. The initial payment in Column C is approximately 23% lower than the first TFRM payment. The initial payment in Column E is approximately 17% lower than the first TFRM payment.

Detailed Methods for Restructuring, Refinancing and/or Workouts

Methods of using CGMs to restructure existing mortgages are described in FIG. 12. In this example, one or more existing mortgage(s) may be replaced by one or more CGM(s).

In the first iteration in FIG. 12, the current principal and remaining term of the existing mortgage(s) and one or more CGMs under consideration are the same. If the existing mortgage is a traditional fixed rate mortgage, the CGM may use the same interest rate. If the existing mortgage is something other than fixed rate, a fixed interest rate is selected. Thus, many other forms of mortgage are transformed from having uncertain future payments to having known future payments.

In this particular application of CGMs, several favorable factors are present:

1. If there is no reduction of principal or interest rate, many lenders and MBS owners will not view it as a loan workout. For a performing loan, the lenders will ultimately receive the same interest rate and return of initial principal.

2. CGMs refinances and/or workouts can be offered to anyone with an outstanding mortgage. Currently, most modifications are offered to borrowers who are in default or distress. CGMs can greatly reduce the administrative burden versus many other loan modifications, because many current methods require looking at income, debt burdens, and other factors to determine eligibility. An extreme example of a huge amount of administrative effort with almost no results was the Hope for Homeowners program. According the Dec. 17, 2008 Washington Post “The three-year program was supposed to help 400,000 borrowers avoid foreclosure. But it has attracted only 312 applications since its October launch because it is too expensive and onerous for lenders and borrowers alike”. In contrast, converting to CGMs can be as simple as showing the borrower their new potential new CGM payment stream, comparing it to their current loan, and having the lender(s)/servicer(s) and borrower(s) sign the new mortgage agreement. With an appropriate data system and automated calculations, thousands of loans could be modified per day into CGMs.

3. Because CGMs can be offered regardless of whether a borrower is in default, distress, average financial condition, or excellent financial condition, backlash against bailouts and loan modifications can be reduced. Presently, a number of responsible people who are current on their loans are upset that others who purchased similar homes for similar prices are being offered loan modifications because they are in default or distress. This is viewed as a moral hazard and/or unfair.

4. A primary cause of default and foreclosure is inability to pay. In a recession, many people have moderate reductions in ability to pay. Payment decreases from CGMs would typically be in the range of ˜10-30% for fixed rate mortgages with interest rates between 4.5% and 8%, without any change in interest rate. Many adjustable rate mortgages which would otherwise have become both unpredictable and unaffordable will become predictable and manageable with CGMs. CGMs have lower monthly payments than traditional fixed rate mortgages for a long time. A 5% CGM will have lower payments than a TFRM for about 12 years.

5. if a mortgage is converted to a CGM and the interest rate is also reduced savings can be considerably larger than from interest rate reductions alone. For example, reducing the interest rate on a 30 year fixed rate mortgage from 8% to 5% results in a drop in payments of about 26%. Switching from an 8% TFRM to a 5% CGM with no negative amortization would result in initial payments being 43% lower.

6. If a large number of loans are converted to CGMs, home price drops will not be as severe, because lower payments lead to fewer foreclosures. The chance of prices dropping far below fundamental values is reduced, as is the related damage to the financial system and the burdens on the US Government and taxpayers.

7. Especially for borrowers in decent to excellent financial condition, lower CGM mortgage payments will allow them to stimulate the economy via other purchases, to pay off other debts (e.g., car, credit card) more quickly, or to save and invest. In some cases, lenders might roll in one or more other types of loan to a CGM. For example, a credit card balance might be included in a new CGM to reduce the overall interest rate and debt service versus leaving the credit card balance separate from the mortgage. This is similar to the home equity line of credit process which has been used previously, except that the mortgage is a CGM.

Turning to FIG. 12, there are multiple ways that one or more existing mortgages might be reviewed for conversion to new CGMs. A lender and/or servicer might choose one or more candidate mortgages for potential review 1201. Candidate mortgages could be chosen from a virtually limitless set of criteria. Such criteria might include: mortgage is in default; mortgage has never been in default; property is located in a particular geographic area; outstanding loan value is above or below a particular amount (e.g., conforming loan limit); estimated current loan to value ratio; initial loan to value ratio; whether the mortgage is part of a particular mortgage backed security pool; identity of lender(s) currently holding the mortgage; type of mortgage (e.g., adjustable rate, fixed, balloon first mortgage, second mortgage, home equity loans); original credit score of borrower(s); current credit score of borrower(s); or prior inquiry from borrower(s) regarding refinancing or workout.

It is also possible that a lender or servicer applies no criteria to determine candidate mortgages, and could commence the process on all of their mortgages, or randomly selected mortgages.

A choice is made at 1203 regarding whether one or more candidate mortgages will have CGM calculations performed before contacting the borrower(s) to make an offer. If the lender(s)/servicer(s) wishes to inquire regarding borrower interest before performing calculations 1205, attempts are made to contact borrower(s) (e.g., mail, Fedex, phone, in person, email). Because many borrowers may be hesitant or suspicious of mortgage modification offers, multiple attempts may be made. Some portion of borrowers will not be found, or will not respond. Other borrowers will respond, but not be interested in modifying their mortgages. For borrowers who do not respond, cannot be found, respond that they are not interested in modifying their mortgages, and any other results of 1207 which do not indicate interest in mortgage modification or replacement, there will be no new mortgage and the process terminates 1223.

If the borrower(s) are interested in modifying or refinancing their mortgage(s) and would like to see the details of one or more CGM choices, the process continues from 1207 to 1209. At 1209, the principal, interest rate, and term of the existing mortgage(s) are used as inputs to CGM calculations.

At 1203, the lender(s) and/or servicer(s) may choose to send offers to one or more borrowers which include proposed dollar amounts of CGM payments. In that case, the process moves to 1209 without contacting the borrower(s) first.

Candidate mortgages for modification or refinance using CGMs might also be prompted by unsolicited requests from borrowers 1211.

CGM calculations 1215, could potentially include any growth rate(s), interest rate(s), modification(s) of principal term(s), or other mortgage characteristics. Any number of constraints might be imposed on one or more CGMs, as discussed in FIG. 10. The lender(s) and/or servicer(s) might offer a single CGM, or might make multiple offers at the same time for a workout or refinancing 1217. Documentation along with the offer 1219, might include: the proposed CGM payments stream(s); a comparison of the existing mortgage with one or more CGM payment streams; principal amortization patterns; and/or various legal and compliance notices. Charts similar to FIGS. 6, 7, 8, and/or 9 might be included.

It is possible that no offer will be made at 1217, in which case there is no new mortgage 1223. For example, it may be obvious to the lender that a particular borrower will not have the ability to make payments on even the most favorable CGM(s) which might be offered to him. As another example, changes in interest rates or ability to modify loans might occur, resulting in some CGMs no longer being available on the same terms or to the same borrower(s).

If the borrower(s) accept an offer of a workout or refinancing using a CGM at 1221, the CGM documents are approved and/or signed by the relevant parties (e.g., the borrower(s), lender(s), servicer(s), title insurer(s), escrow agent(s), private mortgage insurer(s), guarantor(s)) 1225. At that point, the lender(s), and/or mortgage backed security owners have the CGM(s) in their portfolio(s) 1227. Depending on the circumstances, the CGM might be treated as a loan workout, as a new mortgage, or even as if it was the original mortgage with new terms and no implications on the borrower(s)' credit record.

The borrower(s) might not accept any offer for a CGM at 1221. If the lender(s) and/or servicer(s) do not wish to try alternate proposals, or the borrower(s) does not want to see additional proposals, there is no new mortgage 1223. In some cases, the lender(s) and/or servicer(s) might consider alternate proposals 1229. For example, the new proposals might use a different principal, interest, term, and/or growth rate, and CGM calculations 1215 would be performed with the new inputs. Steps 1215 and later could repeat.

Although the description above contains many specificities, these should not be construed as limiting the scope of the embodiments but as merely providing illustrations of some of the presently preferred embodiments. Many other embodiments are possible. For example, the preferred embodiment shows calculations in dollars. Similar calculations can be done in other currencies. Constraints on payments and amortizations could come in a broad variety of forms. Many constraints, such as loan to value ratios, can be restated as amortization constraints, since the down payment will known at the inception of the mortgage. Other constraints, such as affordability and loan payments as a percentage of income, can be restated as payment stream constraints. Numerous modifications and/or additions to the above-described embodiments would be readily apparent to one skilled in the art. It is intended that the scope of the present invention extend to all such modifications and/or additions.

Thus the scope of the embodiments should be determined by the appended claims and their legal equivalents, rather than by the examples given.

What is claimed is:

1. A system which calculates one or more payment streams for constant growth mortgages, wherein:
one or more processors configured to receive input data including information pertaining to principal, interest, payment frequency, and term; and
software which calculates at least one payment stream with a nonzero constant growth rate, and said payment stream has a present value equal to principal when discounted at an applicable interest rate.

2. The system of claim 1, wherein said one or more payment streams are calculated to provide the maximum growth rate which does not cause negative amortization of principal.

3. The system of claim 1, furthermore consisting of:
software which facilitates printing of one or more mortgage documents.

4. A constant growth mortgage, consisting of:
an interest rate
a term
a frequency of payments
a principal amount
a payment stream of two or more payments, wherein
said payments increase at a constant growth rate, said growth rate is known at or before the time the mortgage takes effect, and
said payment stream has a frequency of adjustment of payments at said constant growth rate.

5. The constant growth mortgage of claim 4, wherein:
said fixed growth rate of payments is the maximum growth rate which has a rate of amortization of principal equal to or greater than zero throughout the term of the mortgage.

6. A method of refinancing one or more existing mortgages with a constant growth mortgage, the method comprising the steps of:
determining a payoff value for said one or more existing mortgages,
presenting at least one constant growth mortgage refinancing alternative, and
borrower(s) and lender(s) agree to replace said existing mortgage(s) with a constant growth mortgage.

7. The method of claim 6, wherein
at least one existing mortgage is a fixed rate mortgage.

8. The method of claim 6, wherein
at least one existing mortgage is an adjustable rate mortgage.

9. The method of claim 6, wherein
at least one existing mortgage is a mortgage which is in default.

10. The method of claim 6, wherein
at least one existing mortgage is a mortgage which is not in default.

11. The method of claim 6, with the additional step of:
making a payment on said constant growth mortgage.

12. The method of claim 6, with the additional step of:
receiving a payment on said constant growth mortgage.

13. The method of claim 6, with the additional step of:
adding constant growth mortgage to a mortgage backed security pool.

14. A mortgage where a payment at the CGM level is optional, and said option is provided without requiring consent or signature of the buyer

15. An adjustable rate mortgage, wherein said adjustable rate mortgage amortization is calculated:
using the currently applicable interest rate throughout the remaining term to calculate a payment stream with a constant growth rate

16. The method of claim 15, furthermore consisting of:
calculating a payment stream at a later point in time, where said payment stream may have a different applicable interest rate.

17. An apparatus for the purchase or refinancing of a house comprising:
a mortgage document that indicates three or more payments associated with a constant growth mortgage.

18. A method for modifying an existing mortgage using a constant growth mortgage comprising:
using the same remaining principal, term and frequency of payments as an existing mortgage, and
solving for a payment stream with a constant growth rate greater than zero which amortizes said principal.

19. The method for modifying an existing mortgage using a constant growth mortgage of claim 18, further consisting of:
determining the highest constant growth rate which results in amortization of principal equal to or greater than zero throughout said remaining term of said mortgage.

19. The method for modifying an existing mortgage using a constant growth mortgage of claim 18, wherein:
said payment stream with a constant growth rate greater than zero which amortizes said principal is calculated satisfy one or more constraints on maximum payment amounts.

20. An apparatus consisting of a mortgage backed security containing constant growth mortgages, wherein:
at least one mortgage is a constant growth mortgage.
